(19) United States
(12) Patent Application Publication
(10) Pub. No.: US 2011/0129806 A1
(43) Pub. Date: Jun. 2, 2011

(54) SYSTEM FOR TRAINING

(75) Inventors: LI HUANG, Shenzhen City (CN); MAO-LIN XIA, Shenzhen City (CN); JUN-JIE QUAN, Shenzhen City (CN); FANG-XIN MA, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/701,692

(22) Filed: Feb. 8, 2010

(30) Foreign Application Priority Data
Nov. 30, 2009 (CN) 200910310614.9

(51) Int. Cl. G09B 19/00; G09B 7/00

(52) U.S. Cl. 434/219; 434/362

(57) ABSTRACT

A system for training includes a data storage module, a training course management module, and an examination management module. The data storage module stores at least one employee's personnel information therein. The training course management module includes a training course match unit capable of matching corresponding training course according to the employee's personnel information. The examination management module is capable of generating training suggestion according to an training result of the training course.

### BACKGROUND

1. Technical Field

The present disclosure relates to a management system, and more particularly to a management system for training employees.

2. Description of Related Art

Training employees is an important human resource issue for most of corporations, especially for large corporations. A system must be provided to ensure that employees in different work positions are trained with the corresponding courses. The system also should ensure different employees of different levels have different level courses.

Thus, certain conventional training systems have been developed. However, most of conventional training systems only store a plurality of digital training materials thereon, and employees study these training materials depending on their interest and knowledge. It is often inefficient to train employees.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a system for training.

FIG. 2 is a block view of a training module of the system for training of FIG. 1.

FIG. 3 is a block view of an examination module of the system for training of FIG. 1.

FIG. 4 is a working flow chart of the system for training of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as both software and/or hardware modules and may be stored in any type of computer-readable medium or other computer storage device.

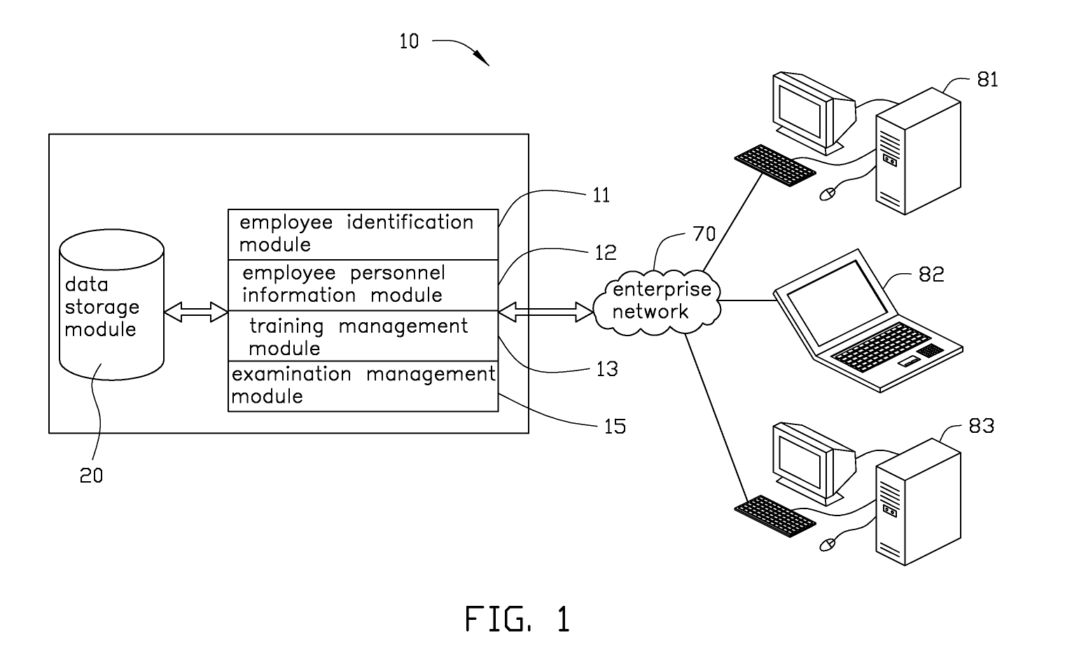

Referring to FIG. 1, a system 10 for training includes a data storage module 20, an employee identification module 11, an employee personnel information module 12, a training management module 13, an examination management module 15, an enterprise network 70, and a plurality of terminals 81, 82, and 83. The plurality of terminals 81, 82, and 83 communicate with these modules 11, 12, 13, and 15 via the enterprise network 70. These modules 11, 12, 13, and 15 are respectively connected to the data storage module 20 to read data from the data storage module 20 or store data in the data storage module 20.

The data storage module 20 stores every employee's personnel information, training information, and score. The employee's personnel information includes employee's name, job number, department, job, work experience, registered username of the system 10, registered password, user authority, and communication manner, etc. The training information includes employee's education background, training completed, and training yet to complete etc. The score information includes score achieved on each training course, employee's total score each month, employee's total score each quarter, employee's total score each year, etc.

The employee identification module 11 is used to identify employee's status according to the inputting of the employee's username and password on terminal. As long as the username and password have been registered in the system 10, the identification module 11 lets the employee enter the system 10, and gives the corresponding employee the extent of user authority according to the employee's personnel information. Simultaneously, a display of the employee's terminal shows a corresponding interface for the employees operation.

The personnel information module 12 is used to add, modify, or delete the employee's personnel information. For example, when a new employee joins a company, the employee's personnel information can be added to the system 10 via the personnel information module 12.

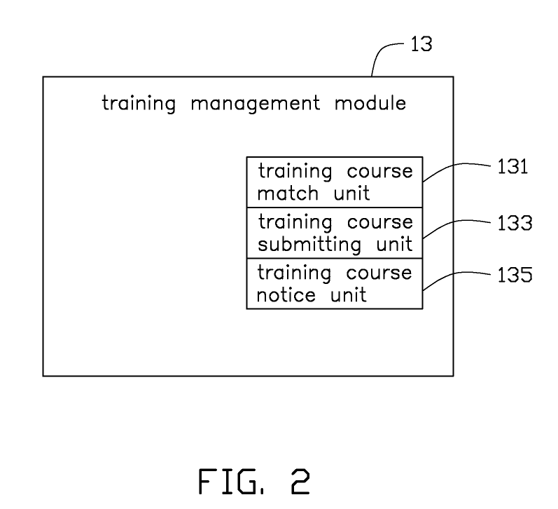

Referring to FIG. 2, the training management module 13 includes a training course match unit 131, a training course submitting unit 133, and a training course notice unit 135. The training course match unit 131 can match corresponding training courses to every employee according to the employee's personnel information. The training course submitting unit 133 is used to submit a request for a course by the employee. For example, if an employee is interested in a course, which is not matched to the employee by the training course match unit 131, the employee can submit a request for the course via the training course submitting unit 133. The training course notice unit 135 is used to automatically provide information of the time and place of the training course according to the employee's communication manner before the training course starts.

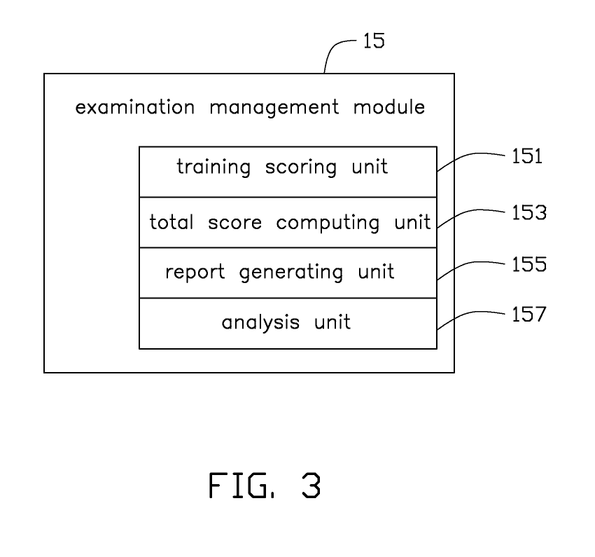

Referring to FIG. 3, the examination management module 15 includes a training scoring unit 151, a total score computing unit 153, a report generating unit 155, and an analysis unit 157. The training scoring unit 151 is used to score the course taken by an employee. There are different methods to score the course, for example, the score from materials submitted online, or accepting the input of scores. The total score computing unit 153 is used to compute a total score of an employee during a certain time period, such as monthly, quarterly, or yearly, etc. The report generating unit 155 is used to generate different reports, such as an employee ranking according to scores, employee scores for different courses or different periods, etc.

The analysis unit 157 is used to analyze the results, and generates some useful suggestions for employees. The suggestions include needed training courses, suitable jobs, etc. The suggestions can be sent back to the employee according to the terminals or the employee's communication manner.

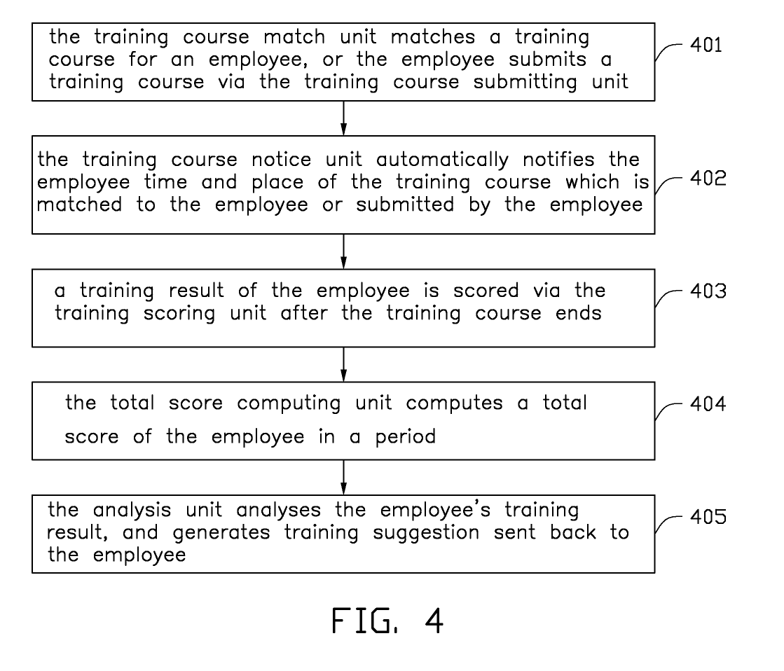

Referring to FIG. 4, a working flow chart of the system 10 is shown. The system 10 works in the following steps:

In step 401, the training course match unit 131 matches a training course for an employee, or the employee submits a training course via the training course submitting unit 133.

In step 402, the training course notice unit 135 automatically notifies the employee time and place of the training course which is matched to the employee or submitted by the employee.

In step 403, after the training course ends, a training result of the employee is scored via the training scoring unit 151.

In step 404, the total score computing unit 153 computes a total score of the employee during a time period.

In step 405, the analysis unit 157 analyses the employee's training result, and generates training suggestion sent back to the employee.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A system for training, comprising:
a data storage module storing at least one employee's personnel information therein;
a training course management module comprising a training course match unit capable of matching corresponding training course according to the employee's personnel information; and
an examination management module capable of generating training suggestion according to an training result of the training course.

2. The system of claim 1, wherein the employee's personnel information comprises at least one of employee's department, job, or work experience.

3. The system of claim 1, wherein the employee's personnel information comprises registered username and password of the employee, the training management system further comprises an employee identification module capable of identify employee's status according to the employee's inputting of username and password on a terminal which is connect to the training management system.

4. The system of claim 1, further comprising an employee personnel information module, wherein the employee personnel information module is capable of adding, modifying, deleting, or a combination thereof, the employee's personnel information.

5. The system of claim 1, wherein the training course management module comprises a training course submitting unit that is capable of submitting a request for a course.

6. The system of claim 1, wherein the training management module further comprises a training course notice unit capable of notifying time and place of the training course before the training courses starts.

7. The system of claim 6, wherein the employee's personnel information comprises a communication manner of the employee, the training course notice unit is capable of notifying the employee according to the employee's communication manner.

8. The system of claim 1, wherein the examination management module comprises a training scoring unit capable of scoring for the employee after the employee is trained by the training course.

9. The system of claim 8, wherein the training scoring unit has different methods to score, the different methods comprises computing the score from materials submitted online, or accepting the input of scores.

10. The system of claim 8, wherein the examination management module comprises a total score computing unit capable of computing a total score of the employee's training courses in a period.

11. The system of claim 8, wherein the examination management module comprises a report generating unit capable of generating report which can represent at least one of an employ rankings according to scores, or employee's scores for different courses or different period.

12. The system of claim 1, wherein the training suggestion comprises at least one of needed training suggestion, or suitable job suggestion.

13. A system for training, comprising:
a data storage module storing one employee's personnel information therein;
a training course management module comprising a training course match unit capable of matching corresponding training course according to the employee's personnel information; and
an examination management module comprising a training scoring unit and an analysis unit, the training scoring unit capable of scoring for the employee after the employee is trained by the training course; and the analysis unit capable of analyzing the employee's personnel information and a score scored by the training scoring unit, and generating corresponding training suggestions.

14. The system of claim 13, wherein the employee's personnel information comprises at least one of the employee's department, job, or work experience.

15. The system of claim 13, wherein the employee's personnel information comprises registered username and password of the employee, the training management system further comprises an employee identification module capable of identify employee's status according to the employee's inputting of username and password on a terminal which is connect to the training management system.

16. The system of claim 13, wherein the training course management module comprises a training course submitting unit that is capable of submitting a request for a course.

17. The system of claim 13, wherein the training management module further comprises a training course notice unit capable of notifying time and place of the training course before the training courses starts.

18. The system of claim 17, wherein the employee's personnel information comprises a communication manner of the employee, the training course notice unit is capable of notifying the employee according to the employee's communication manner.

19. The system of claim 13, wherein the examination management module comprises a total score computing unit capable of computing a total score of the employee's training courses in a period.
